(19) United States
(12) Patent Application Publication
(10) Pub. No.: US 2013/0087017 A1
(43) Pub. Date: Apr. 11, 2013

(54) STARTER

(71) Applicant: DENSO CORPORATION, Kariya-city (JP)

(72) Inventors: Akina KUWADA, Kariya-shi (JP); Takuma KOUDU, Kariya-shi (JP)

(73) Assignee: DENSO CORPORATION, Kariya-city (JP)

(21) Appl. No.: 13/644,519

(22) Filed: Oct. 4, 2012

(30) Foreign Application Priority Data
Oct. 7, 2011 (JP) 2011-222515

(51) Int. Cl. F02N 15/02

(52) U.S. Cl. 74/7 C

(57) ABSTRACT

The pinion tube is supported by an output shaft in an inner circumference of a cylindrical hole, an inner circumference side pressure-receiving range α that receives a contacting pressure from the output shaft is formed on a sliding surfaces, the pinion tube is further supported by a bearing from a perimeter side thereof, and a perimeter side pressure-receiving range that receives the contacting pressure from the bearing is formed on a sliding surfaces. There exists an overlapping range that overlaps in the axial direction in the inner circumference side and the perimeter side pressure-receiving ranges, and a length of the overlapping range in the axial direction is always equal to a length of the perimeter side pressure-receiving range in the axial direction even if the pinion tube moves in the axial direction.

### CROSS-REFERENCE TO RELATED APPLICATION

This application is based on and claims the benefit of priority from earlier Japanese Patent Application No. 2011-222515 filed Oct. 7, 2011, the description of which is incorporated herein by reference.

### TECHNICAL FIELD

The present disclosure relates to a starter that has a system of having a pinion tube that meshes with a perimeter of an output shaft in a spline fitting manner, and a pinion supported by an end of the pinion tube in an anti-motor side in an axial direction is meshed with an engine ring gear by pushing out the pinion tube in an anti-motor side direction relative to the output shaft.

### BACKGROUND

Conventionally, a starter with a cantilever structure is disclosed in Japanese Patent Application Laid-Open Publication No. 2006-177168.

The starter includes an output shaft 100, a pinion tube 120, a one-way clutch 130, a pinion 140, and a housing 160, as shown in FIGS. 7A and 7B.

The output shaft 100 is driven by a motor (not shown), and the pinion tube 120 is fit to a perimeter of the output shaft 100 via bearings 110.

The one-way clutch 130 is of a roller type that transmits rotation of the output shaft 100 to the pinion tube 120, and the pinion 140 is meshed with an end of the pinion tube 120 in an anti-motor side in an axial direction (left-hand side in the drawings) in a direct spline fitting manner.

The housing 160 supports the pinion tube 120 through a bearing 150 disposed between the clutch 130 and the pinion 140.

The starter has a system that pushes out the pinion tube 120 together with the clutch 130 in the anti-motor side direction (left-hand side in the drawing) relative to the output shaft 100, and meshes the pinion 140 with an engine ring gear when triggered by an electromagnetic switch (not shown).

In the starter mentioned above, when the engine has started due to cranking and the pinion 140 is rotated by the engine, the clutch 130 becomes in an overrun state and the torque transmission from an inner side to an outer side is intercepted.

At this time, a number of rotations of the pinion 140 and the pinion tube 120 that are rotated by the engine becomes larger than a number of rotations of the output shaft 100 that is driven by the motor, and a relative number of rotations of the pinion 140 and the pinion tube 120 to the output shaft 100 becomes large.

For this reason, the following supporting structure is constituted between the output shaft 100 and the pinion tube 120.

That is, the bearings 110 are disposed between the pinion tube 120 and the output shaft 100, and the bearings 110 are press fit to an inner circumference of the pinion tube 120 so that the bearings 110 are movable with the pinion tube 120 in an axial direction.

Then the output shaft 100 is inserted into inner circumferences of the bearings 110 relatively rotatably.

Thus, the pinion tube 120 is supported by the output shaft 100 from the inner circumference side through the bearings 110 that are press fit to the pinion tube 120, and is further supported from the perimeter side by a bearing 150 that is located at a constant axial position relative in the axial direction to the output shaft 100.

Thereby, the pinion tube 120 forms an inner circumference side pressure-receiving range φ that receives contacting pressure from the output shaft 100 through the bearings 110 on an inner surface, and a perimeter side pressure-receiving range ψ that receives contacting pressure from the bearing 150 on an outer surface.

In addition, the inner circumference side pressure-receiving range φ moves in the anti-motor side direction relative to the output shaft 100 when the pinion tube 120 is pushed out by the operation of the electromagnetism switch.

For this reason, in a case of the starter that the inner circumference side and the perimeter side pressure-receiving ranges φ and ψ overlap in the axial direction when both the starter is driven and stopped, for example, an overlapping range ω in the axial direction of the inner circumference side and the perimeter side pressure-receiving ranges φ and ψ changes its length in the axial direction and its position in the axial direction during the starter is driven or stopped.

In addition, the time when the starter is driven means that the pinion 140 is meshed with a ring gear of the engine, and the torque generated by the motor is transmitted to the ring gear from the pinion 140 to crank (start) the engine.

By the way, in the starter in which the overlapping range ω exists during the starter is driven and stopped, a big load is applied to the overlapping range ω by the pinion 140 meshing with the ring gear.

Moreover, there is a possibility that wear occurs under the influence of the load so that the pinion tube 120 may incline relative to the output shaft 100, or the output shaft 100 may incline relative to the pinion tube 120.

For this reason, the inner circumference side and the perimeter side pressure-receiving ranges φ and ψ are configured so that the overlapping range ω becomes large when the starter is driven, and the overlapping range ω becomes small when the starter is stopped as compared with the overlapping range ω when the starter is driven.

That is, in the conventional starter, the overlapping range ω when the starter is driven is made large, and the contacting pressure that acts on the pinion tube 120 from the output shaft 100 when the starter is driven and the contacting pressure that acts on the output shaft 100 from the pinion tube 120 when the starter is driven are made small, thus an influence of the load applied onto the overlapping range ω when the starter is driven is eased.

However, even if the starter is stopped, external force acts on the starter by, for example, receiving vibration from a vehicle body that is running.

For this reason, the load accompanying body vibration etc. is applied to the overlapping range ω, and there is a possibility that wear occurs under the influence of the load so that the pinion tube 120 may incline to the output shaft 100, or the output shaft 100 may incline to the pinion tube 120.

Moreover, although the load applied to the overlapping range ω the starter is stopped is assumed to be small compared with the load applied when the starter is driven, it is considered that the influence affecting to wear cannot be disregarded.

Moreover, in recent years, vehicles employing an idling stop system (ISS) that stops fuel injection to an engine to stop the engine automatically when the vehicle stops at a traffic light or during a traffic jam, etc. are increasing.

In the vehicles that employ the ISS, as compared with the vehicles that do not employ the ISS, the frequency of starting the engine increases sharply, while a number of times of operating the starter also increases sharply.

As more and more vehicles are using ISS, there is high demand for starters having well-aligned output shafts 100 and pinion tubes 120, to extend the life of the starter.

### SUMMARY

An embodiment provides a starter with a cantilever structure that suppresses an inclination of a pinion tube or a pinion relative and extends the life of the starter.

In a starter according to a first aspect, the starter includes a motor that generates torque, an output shaft disposed coaxially with a rotating shaft of the motor, a male spline formed on an outer surface of the output shaft, and a clutch that transmits the torque generated by the motor to the output shaft.

The starter further includes a pinion tube that has a cylindrical hole where a female spline is formed in an inner surface thereof and an anti-motor side in an axial direction of the output shaft is inserted into an inner circumference of the cylindrical hole so that the male spline and the female spline are meshed, a pinion disposed on an end of the pinion tube in the anti-motor side in the axial direction and which rotates together with the pinion tube, and an electromagnetic solenoid that drives a shift lever by an attraction force of an electromagnet and pushes out the pinion tube together with the pinion in the anti-motor side direction relative to the output shaft via the shift lever.

The pinion is engaged with a ring gear of an engine by pushing out the pinion tube in the anti-motor side direction relative to the output shaft when triggered by the electromagnetic solenoid.

The pinion tube is supported by the output shaft in the inner circumference of the cylindrical hole, an inner circumference side pressure-receiving range that receives a contacting pressure from the output shaft is formed on the inner surface of the pinion tube, the pinion tube is supported by a bearing located at a constant axial position relative to the output shaft in the axial direction from a perimeter side thereof, and a perimeter side pressure-receiving range that receives the contacting pressure from the bearing is formed on an outer surface of the pinion tube.

The bearing is located at a constant axial position relative to the output shaft in the axial direction so as to overlap with the output shaft in the axial direction, and an end of the output shaft in the anti-motor side in the axial direction is in aside of a motor of the perimeter side pressure-receiving range in the axial direction beyond an end in the anti-motor side in the axial direction, and is in the anti-motor side of the perimeter side pressure-receiving range in the axial direction beyond an end in the motor side in the axial direction.

There exists an overlapping range that overlaps in the axial direction in the inner circumference side pressure-receiving range and the perimeter side pressure-receiving range, and a length of the overlapping range in the axial direction substantially matches the length of the overlap between the output shaft and the bearing in the axial direction even if the pinion tube moves in the axial direction.

Thereby, the inclination of the output shaft or the pinion tube can be suppressed, and a longer service life can be attained since the overlapping range can be maintained to a maximum constantly regardless of the starter being driven or stopped in the starter with a cantilever structure.

That is, when the end of the output shaft in the anti-motor side in the axial direction is in the motor side of the perimeter side pressure-receiving range in the axial direction beyond the end in the anti-motor side in the axial direction, and is in the anti-motor side of the perimeter side pressure-receiving range in the axial direction beyond the end in the motor side in the axial direction (i.e., when the end of the output shaft in the anti-motor side in the axial direction is within the perimeter side pressure-receiving range), the length of the overlapping range in the axial direction can be maximized by substantially matching the length of the overlapping range in the axial direction with the overlapping length of the output shaft and the bearing in the axial direction.

Moreover, the length of the overlapping range in the axial direction can be maintained to the maximum regardless of the starter being driven or stopped.

For this reason, the contacting pressure that acts on the pinion tube from the output shaft and the contacting pressure that acts on the output shaft from the pinion tube can be minimized regardless of the starter being driven or stopped, thus wear can be suppressed.

As a result, the inclination of the pinion tube to the output shaft and the inclination of the pinion tube 6 to the output shaft can be suppressed, thus the a longer service life of the starter can be attained in the starter of the cantilever structure.

Here, the supporting structure constituted between the output shaft and the pinion tube may be formed by directly contacting the inner surface that forms a cylindrical hole (inner surface of the pinion tube) and the outer surface of the output shaft, for example (hereafter called a direct contacting type).

Moreover, the supporting structure may be formed by inserting the bearing etc. between the inner surface of the pinion tube and the outer surface of the output shaft, and indirectly contacting the inner surface of the pinion tube and the outer surface of the output shaft (hereafter called an indirect contacting type).

Further, although it is assumed that the inclination occurs by wear of the outer surface of the output shaft or the inner surface of the pinion tube when using the direct contacting type as the supporting structure, and it is assumed the inclination occurs by wear of the outer surface of the output shaft the inner surface of the bearing when using the indirect contacting type as the supporting structure, occurrence of the inclination can be suppressed in either direct or indirect contacting type and the a longer service life of the starter can be attained.

In the starter according to a second aspect, the starter includes a motor that generates torque, an output shaft disposed coaxially with a rotating shaft of the motor, a male spline formed on an outer surface of the output shaft, and a clutch that transmits the torque generated by the motor to the output shaft.

The starter further includes a pinion tube that has a cylindrical hole where a female spline is formed in an inner surface thereof and an anti-motor side in an axial direction of the output shaft is inserted into an inner circumference of the cylindrical hole so that the male spline and the female spline are meshed, a pinion disposed on an end of the pinion tube in the anti-motor side in the axial direction and which rotates together with the pinion tube, and an electromagnetic solenoid that drives a shift lever by an attraction force of an electromagnet and pushes out the pinion tube together with the pinion in the anti-motor side direction relative to the output shaft via the shift lever.

The pinion is engaged with a ring gear of an engine by pushing out the pinion tube in the anti-motor side direction relative to the output shaft when triggered by the electromagnetic solenoid.

The pinion tube is supported by the output shaft in the inner circumference of the cylindrical hole, an inner circumference side pressure-receiving range that receives a contacting pressure from the output shaft is formed on the inner surface of the pinion tube, the pinion tube is supported by a bearing located at a constant axial position relative to the output shaft in the axial direction from a perimeter side thereof, and a perimeter side pressure-receiving range that receives the contacting pressure from the bearing is formed on an outer surface of the pinion tube.

There exists an overlapping range that overlaps in the axial direction in the inner circumference side pressure-receiving range and the perimeter side pressure-receiving range, and a length of the overlapping range in the axial direction is always equal to a length of the perimeter side pressure-receiving range in the axial direction even if the pinion tube moves in the axial direction.

Thereby, the inclination of the output shaft or the pinion tube can be suppressed, and a longer service life can be attained since the overlapping range can be maintained to a maximum constantly regardless of the starter being driven or stopped in the starter with a cantilever structure.

That is, when the end of the output shaft in the anti-motor side in the axial direction is in the anti-motor side of the perimeter side pressure-receiving range in the axial direction beyond the end in the anti-motor side in the axial direction, the length of the overlapping range in the axial direction can be maximized by substantially matching the length of the overlapping range in the axial direction with the perimeter side pressure-receiving range in the axial direction, and the length of the overlapping range in the axial direction can be maintained to the maximum regardless of the starter being driven or stopped.

For this reason, the contacting pressure that acts on the pinion tube from the output shaft and the contacting pressure that acts on the output shaft from the pinion tube can be minimized regardless of the starter being driven or stopped, thus wear can be suppressed.

As a result, the inclination of the pinion tube to the output shaft and the inclination of the pinion tube 6 to the output shaft can be suppressed, thus the a longer service life of the starter can be attained in the starter of the cantilever structure.

In addition, the supporting structure constituted between the output shaft and the pinion tube in the disclosure of the second aspect can be assumed to the contact type or the indirect contacting type similar to the disclosure of the first aspect.

Moreover, the occurrence of wear can be assumed similar to the disclosure of the first aspect.

Here, the disclosure of the first aspect suppresses the wear in the supporting structure by maximizes the overlapping range when the end of the output shaft in the anti-motor side in the axial direction is within the perimeter side pressure-receiving range.

Moreover, the disclosure of the second aspect suppresses the wear in the supporting structure by maximizing the overlapping range when the end of the output shaft in the anti-motor side in the axial direction is in the anti-motor side of the perimeter side pressure-receiving range in the axial direction.

Further, configuring the end in the anti-motor side of the axial direction of the output shaft within the perimeter side pressure-receiving range or in the anti-motor side of the perimeter side pressure-receiving range in the axial direction can be chosen based on the moment of force that acts on parts disposed coaxially such as the output shaft, the pinion tube, the pinion, the motor, and the components of the speed reducer (the parts other than the pinion are hereafter called pinion coaxial parts among these parts).

That is, when a area supported by the bearing is used as a fulcrum of the moment of force that acts on the pinion and the pinion coaxial parts, the pinion coaxial parts receive load via the pinion from the ring gear when starting the engine, and the moment by these loads balances.

Here, it is desirable that the load received by the pinion coaxial parts is smaller because it causes wear.

Then, the moment of the load that the pinion receives from the ring gear can be reduced, and as a result, the load that the pinion coaxial parts receive can be reduced by bringing the bearing closer to the pinion in the axial direction, and configuring the end of the output shaft in the anti-motor side in the axial direction in the perimeter side pressure-receiving range.

Therefore, configuring the end in the anti-motor side of the axial direction of the output shaft within the perimeter side pressure-receiving range or in the anti-motor side of the perimeter side pressure-receiving range in the axial direction can be chosen depending on to what extent reducing the moment of force that acts on the pinion and the pinion coaxial parts, etc., especially the moment due to the load that the pinion receives from the ring gear when the engine is started.

### BRIEF DESCRIPTION OF THE DRAWINGS

In the accompanying drawings:

FIG. 1 shows a block diagram showing an entire starter (first embodiment);

FIG. 2A shows a block diagram showing a principal part of FIG. 1 when a starter is stopped (first embodiment);

FIG. 2B shows a block diagram showing a principal part of FIG. 1 when the starter is driven (first embodiment);

FIG. 3A shows a diagram showing an inner circumference side and a perimeter side pressure-receiving range and an overlapping range when the starter is stopped (first embodiment);

FIG. 3B shows a diagram showing an inner circumference side and a perimeter side pressure-receiving range and an overlapping range when the starter is driven (first embodiment);

FIG. 4A shows a diagram showing an inner circumference side and a perimeter side pressure-receiving range and an overlapping range when the starter is stopped (first comparative example);

FIG. 4B shows a diagram showing an inner circumference side and a perimeter side pressure-receiving range and an overlapping range when the starter is driven (first comparative example);

FIG. 5A shows a diagram showing an inner circumference side and a perimeter side pressure-receiving range and an overlapping range when the starter is stopped (second comparative example);

FIG. 5B shows a diagram showing an inner circumference side and a perimeter side pressure-receiving range and an overlapping range when the starter is driven (second comparative example);

FIG. 6A shows a diagram showing an inner circumference side and a perimeter side pressure-receiving range and an overlapping range when the starter is stopped (second embodiment);

In FIG. 6B shows a diagram showing an inner circumference side and a perimeter side pressure-receiving range and an overlapping range when the starter is driven (second embodiment);

FIG. 7A shows a block diagram showing a principal part when a starter is stopped; and

FIG. 7B shows a block diagram showing a principal part when the starter is driven;

### DETAILED DESCRIPTION OF THE PREFERRED EMBODIMENTS

With reference to the drawings, hereinafter will be described embodiments of the present disclosure.

### First Embodiment

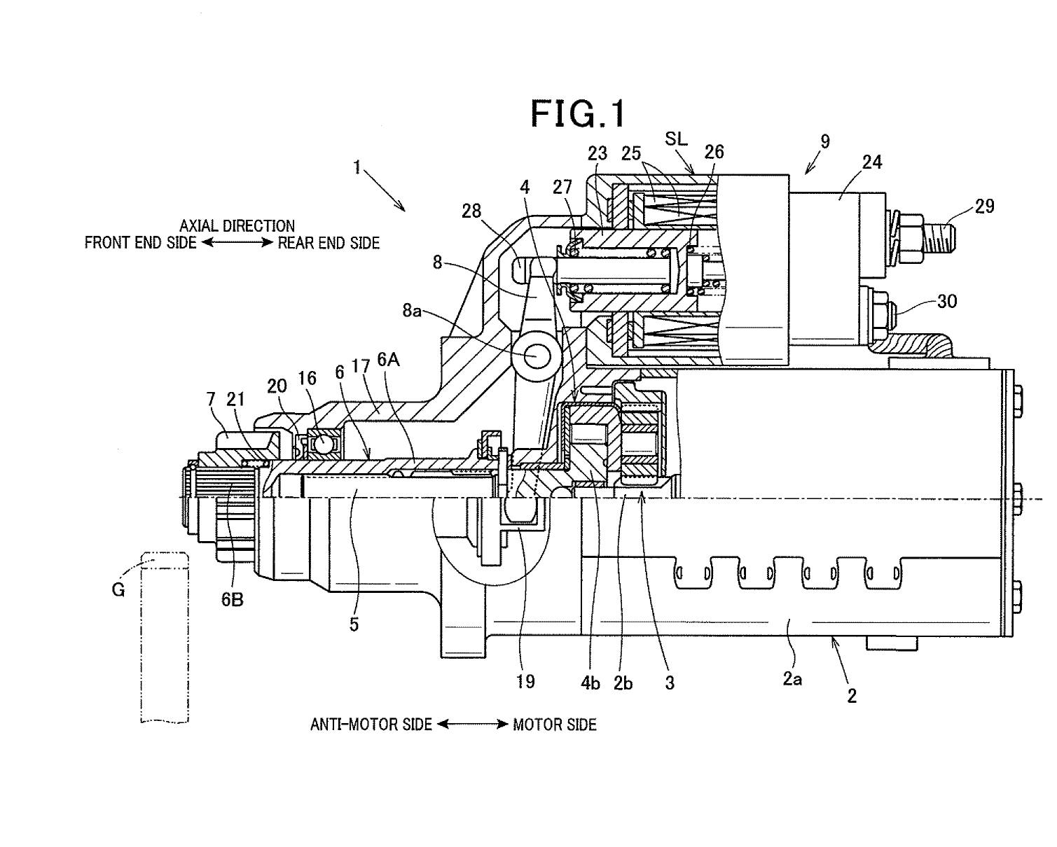

As shown in FIG. 1, a starter 1 includes a motor 2, a speed reducer 3, an output shaft 5, a pinion tube 6, a pinion 7, and an electromagnetic switch 9.

The motor 2 generates torque and its rotation speed is slowed down by the speed reducer 3.

The output shaft 5 is connected with an output side of the speed reducer 3 through a clutch 4, and the pinion tube 6 is meshed in a spline fitting manner to a perimeter of the output shaft 5.

The pinion 7 is attached to an end in an anti-motor side in an axial direction of the pinion tube 6, and rotates together with the pinion tube 6.

The electromagnetic switch 9 drives a shift lever 8 by an attraction force of an electromagnet, and pushes out the pinion tube 6 together with the pinion 7 relative to the output shaft 5 through the shift lever 8.

Moreover, the electromagnetic switch 9 opens and closes a main point of contact, which is mentioned later, and intermits an energizing current of the motor 2.

Here, a motor side in the axial direction (right-hand side in the drawing) is defined as a rear end side, and an anti-motor side in the axial direction (a side opposite to the motor 2) is defined as a front end side in the following explanation.

Moreover, a direction where the pinion tube 6 is pushed out by the electromagnetic switch 9 relative to the output shaft 5 (left-hand side in the drawing) is defined as an anti-motor side direction, and a direction where the pinion tube 6 is pushed back is defined as a motor side direction.

The motor 2 is a direct-current commutator motor, for example, that includes a magnetic field constituted by arranging a permanent magnet (a field coil may be sufficient) in an inner circumference of a yoke 2a that serves as a frame, an armature (not shown) that has a commutator (not shown) on an outer surface of an armature shaft 2b, and a brush (not shown) disposed on an outer surface of the commutator.

The motor 2 generates torque in the armature by an interaction with the magnetic field when the main point of contact is closed by the electromagnetic switch 9 and the armature is energized.

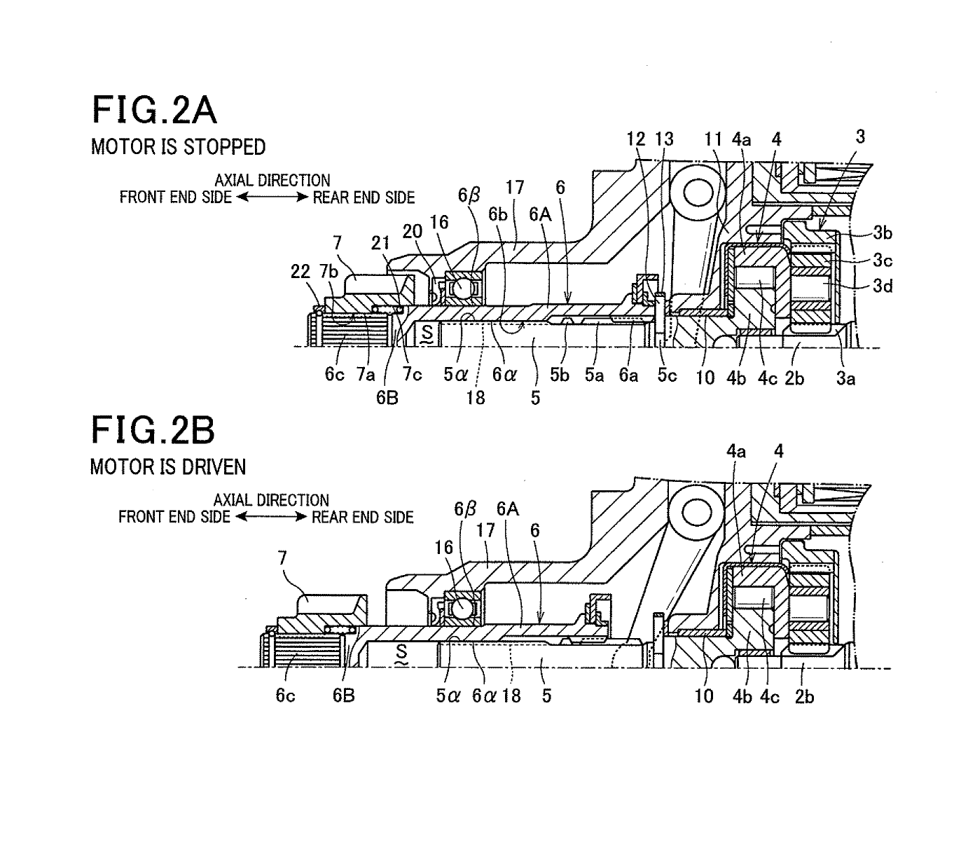

The speed reducer 3 has a sun gear 3a disposed on an anti-commutator side (left-hand side in the drawing) of the armature shaft 2b, a ring-shaped internal gear 3b arranged coaxially with the sun gear 3a, and a plurality of (for example, three) planetary gears 3c that mesh with the sun gear 3a and the internal gear 3b, as shown in FIGS. 2A and 2B.

The speed reducer 3 is a planetary gear speed reducer such that the planetary gears 3c rotate and revolve around the sun gear 3a in accordance with a rotation of the sun gear 3a.

The clutch 4 includes an outer 4a disposed together with gear shafts 3d that rotatably support the planetary gears 3c of the speed reducer 3, an inner 4b disposed relatively rotatable to an inner circumference of the outer 4a, and rollers 4c (power intermittence member of the present disclosure) disposed between the outer 4a and the inner 4b, as shown in FIGS. 2A and 2B.

The clutch 4 is a one-way clutch that transmits running torque to the inner 4b from the outer 4a through the rollers 4c, while intercepts the torque transmission from the inner 4b to the outer 4a because the rollers 4c idle.

As shown in FIGS. 2A and 2B, the output shaft 5 is disposed coaxially with the armature shaft (rotating shaft) 2b of the motor 2.

An end of the output shaft 5 in the rear end side (right-hand side in the drawing) is disposed together with the inner 4b of the clutch 4, and the outer surface of the output shaft 5 is rotatably supported by a center case 11 through a bearing 10.

Moreover, a male helical spline 5a is formed on the outer surface of the output shaft 5 in the front end side of the outer surface where is supported by the bearing 10, and a stopper 5b that suppresses a maximum advanced position of the pinion tube 6 is formed on a front end surface in the front end side of the male helical spline 5a.

Further, a circumferential slot 5c is recessed in all the circumferences between the outer surface that is supported by the bearing 10 of the output shaft 5 and the male helical spline 5a, and a stopper member 12 that suppresses a stopping position of the pinion tube 6 in the circumferential slot 5c is attached.

The stopper member 12 is an E-clip, for example, and the E-clip is used by inserting it in the perimeter of the circumferential slot 5c.

In addition, two or more sheets of the E-clip may be used.

Moreover, a cover 13 may be put on the perimeter of the E-clip so that the E-clip may not come off from the circumferential slot 5c by the centrifugal force that occurs when the output shaft 5 rotates.

As shown in FIGS. 2A and 28, the pinion tube 6 has a main tube body 6A that has a cylindrical hole 6b where a female helical spline 6a is formed in an inner surface thereof, and a pinion sliding part 6B disposed in the front end side from the main tube body 6A.

As for the pinion tube 6, an outer surface of the main tube body 6A is supported by a housing 17 through a bearing 16 slidably in the axial direction.

Moreover, the output shaft 5 is inserted into the inner circumference of the cylindrical hole 6b, and the female helical spline 6a meshes with the male helical spline 5a.

Thereby, the pinion tube 6 is attached to be rotatable and movable in the axial direction relative to the output shaft 5.

The maximum advanced position of the pinion tube 6 mentioned above is suppressed since the front end side of the female helical spline 6a contacts the rear end side of the stopper 5b.

In addition, although a ball bearing is used for the bearing 16, a slide bearing (plain bearing) or a needle bearing may be used in FIG. 1 and FIGS. 2A and 2B.

Moreover, the bearing 16 is located at a constant axial position relative to the output shaft 5 in the axial direction.

Inner diameters of the cylindrical hole 6b of the main tube body 6A differ in the front end side and rear end side from an approximately central part thereof in the axial direction. The inner diameter in the rear end side is formed larger than that of the front end side, and the female helical spline 6a is formed on the inner surface in the rear end side.

The inner diameter in the rear end side of the cylindrical hole 6b is formed approximately the same size as a tooth bottom diameter of the female helical spline 6a.

Moreover, a clearance that arises between the inner circumference side of the cylindrical hole 6b and the perimeter side of the output shaft 5 is configured smaller than a clearance that arises between the male helical spline 5a and the female helical spline 6a in the forward end side of the cylindrical hole 6b.

Thereby, the inner circumference side in a tip side of the cylindrical hole 6b and the perimeter side of the forward end side portion of the output shaft 5 form sliding surfaces 6α and 5α that slide mutually.

Moreover, outer diameters of the main tube body 6A differ in the front end side and rear end side from approximately central part thereof in the axial direction. An outer diameter in the rear end side is formed larger than that in the forward end side, and the bearing 16 is disposed on the outer surface of the forward end side of the main tube body 6A.

Thereby, the outer surface of the forward end side portion of the main tube body 6A forms a sliding surface 6p that slides relative to the inner surface of the bearing 16.

Furthermore, from the time when the starter is stopped shown in FIG. 2A till the time when the starter is driven shown in FIG. 2B, a communicating slot 18 that communicates a space S formed between an end in the forward end side of the output shaft 5 (hereafter called a forward end 5s) and a bottom in the axial direction of the cylindrical hole 6b and the rear end side of the cylindrical hole 6b is formed in the axial direction to at least one of the sliding surfaces 5α and 6α.

In addition, the time when the starter is driven means the time when the pinion 7 is already meshed with a ring gear G of an engine (refer to FIG. 1), and the torque generated by the motor 2 is transmitted to the ring gear G from the pinion 7 to crank (start) the engine.

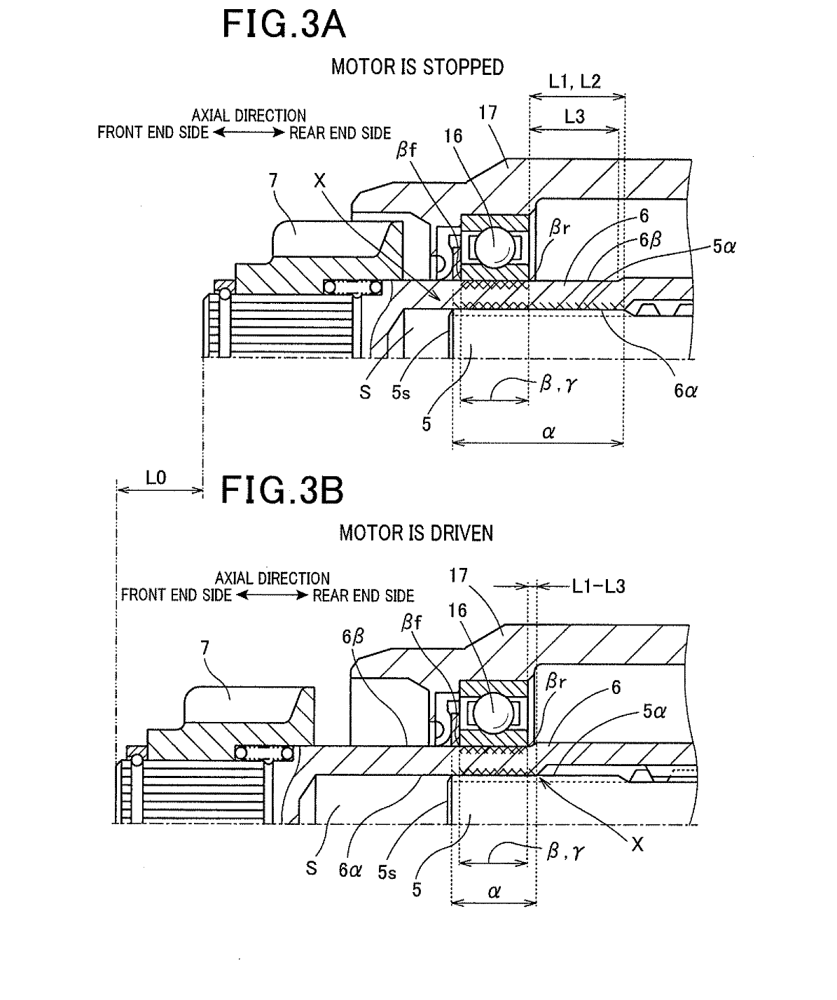

Accordingly, as shown in FIG. 3A and FIG. 3B, the pinion tube 6 is supported by the output shaft 5 in the inner circumference of the cylindrical hole 6b, and forms an inner circumference side pressure-receiving range α that receives a contacting pressure from the output shaft 5 on the sliding surface 6α.

Furthermore, the pinion tube 6 is supported by the bearing 16 from the perimeter side, and forms a perimeter side pressure-receiving range β that receives a contacting pressure from the bearing 16 on the sliding surfaces 6β.

Moreover, the forward end 5s of the output shaft 5 is in the forward end side beyond a forward end βf of the perimeter side pressure-receiving range β.

Further, an overlapping range γ that overlaps in the axial direction exists in the inner circumference side pressure-receiving range α and the perimeter side pressure-receiving range β, and the length of the overlapping range γ in the axial direction is always equal to length of the perimeter side pressure-receiving range β in the axial direction even if the pinion tube 6 moves in the axial direction.

That is, the bearing 16 is located at a constant axial position relative to the output shaft 5 in the axial direction so as to overlap with the output shaft 5 in the axial direction, and length of the overlap of the output shaft 5 and the bearing 16 substantially matches with the overlapping range γ in the axial direction.

Further, the sliding surfaces 5α, 6α, and 6β are configured as follows so that the overlapping range γ may always be equal to the length of the perimeter side pressure-receiving range β in the axial direction irrespective of the time of the starter 1 being stopped or driven.

Namely, when the starter 1 is stopped, the sliding surfaces 5α, 6α, and 6β are extended to the rear end side beyond a rear end βr of the perimeter side pressure-receiving range β for a length in the axial direction more than a pushed-out length (hereafter called a movement value L0) in the axial direction of the pinion tube 6 and the pinion 7 moved by the operation of the electromagnetism switch 9.

When lengths in the axial direction to which the sliding surfaces 5α, 6α, and 6β extend in the rear end side beyond the rear end βr when the starter 1 is stopped are configured as length L1, L2, and L3, respectively, the length L3 is equal to the movement value L0, the length L1 and L2 are equal to each other and are longer than the movement value L0 and the length L3 in the first embodiment, as shown in FIG. 3A.

Thereby, the length in the axial direction of the inner circumference side pressure-receiving range α became the longest when the starter 1 is stopped, and the inner circumference side pressure-receiving range α is extended only by the length L1 in the rear end side beyond the rear end βr.

Moreover, the length in the axial direction of the inner circumference side pressure-receiving range α became the shortest when the starter 1 is driven, and the inner circumference side pressure-receiving range α is extended only the length (L1-L3) in the rear end side beyond the rear end βr.

Further, an area that the inner circumference side pressure-receiving range a occupies in the sliding surfaces 6α is variable, and the inner circumference side pressure-receiving range a occupies a large area from a position near the forward end of the sliding surfaces 6α to the rear end of the sliding surfaces 6α when the starter 1 is stopped, and occupies a narrow area in the rear end of the sliding surfaces 6α when the starter 1 is driven.

Similarly, an area that the perimeter side pressure-receiving range β occupies in the sliding surfaces 6β is also variable, and the perimeter side pressure-receiving range β occupies a forward end area slightly beyond from a center of the sliding surfaces 6β when the starter 1 is stopped, and occupies an area in the rear end of the sliding surfaces 6β when the starter 1 is driven.

In addition, a total area of the perimeter side pressure-receiving range β is constant irrespective when the starter 1 is stopped or driven.

As shown in FIG. 1, a lever engaging portion 19 that engages with an end of the shift lever 8 is disposed to an end in the rear end side of the main tube body 6A.

Moreover, a sealing member 20 that prevents intrusion of foreign substances from the outside to the front end side of the bearing 16 is disposed in a perimeter of the main tube body 6A.

The sealing member 20 is an oil seal made of rubber, for example, and is held at the housing 17 in the state where a lip part of the sealing member 20 is contacted to the outer surface of the main tube body 6A.

An outer diameter of the pinion sliding part 6B is formed smaller than that of the main tube body 6A, and direct spline teeth 6c are formed in the outer surface in the axial direction (refer to FIGS. 2A and 213).

The pinion 7 is formed separately with the pinion tube 6 and attached to the pinion sliding part 6B movably in the axial direction relative to the pinion sliding part 6B.

Moreover, the pinion 7 is energized by a pinion spring 21 to the front end side of the pinion sliding part 6B, and movement in the axial direction is suppressed by a pinion stopper 22 attached to the end in the front end side of the pinion sliding part 6B.

Further, as shown in FIGS. 2A and 28, the pinion 7 has a slide hole 7b and a large hole 7c. The slide hole 7b opens to the inner circumference in the front end side of the pinion 7 and direct spline slots 7a are formed in the inner surface in the axial direction. The large hole 7c communicates with the slide hole 7b and opens to the inner circumference in the rear end side of the pinion 7, while an inner diameter of the large hole 7c is formed larger than that of the slide hole 7b.

Furthermore, the pinion sliding part 6B is inserted into the inner circumference of the slide hole 7b through the inner circumference of the large hole 7c, and the direct spline teeth 6c mesh with the direct spline slots 7a, so that the pinion 7 is attached to the pinion sliding part 6B movably in the axial direction relative to the pinion sliding part 6B.

Moreover, in the pinion 7, the perimeter of the end in the front end side of the main tube body 6A meshes with the inner circumference of the end in the rear end side of the large hole 7c.

The pinion spring 21 is arranged between a stepped surface formed between the main tube body 6A of the pinion tube 6 and the pinion sliding part 6B in the radial direction, and a stepped surface formed between the large hole 7c of the pinion 7 and the slide hole 7b in the radial direction.

As shown in FIG. 1, the electromagnetic switch 9 has a solenoid SL (electromagnetic solenoid of the present disclosure) that drives a plunger 23 by the attraction force of the electromagnet, and a resin cover 24 that has the main point of contact disposed therein. The resin cover 24 is fixed by crimping to an opening end of a frame that serves as a magnetic circuit of solenoid SL.

The solenoid SL includes an exciting coil 25, the plunger 23, a return spring 26, a drive spring 27, and a joint 28 etc.

The exciting coil 25 forms the electromagnet by energizing, and the plunger 23 is arranged in the inner circumference of the exciting coil 25 movably in the axial direction.

The return spring 26 pushes back the plunger 23 when the energizing to the exciting coil 25 is stopped and the attraction force of the electromagnet disappears and the drive spring 27 conserves a reaction force for meshing the pinion 7 to the ring gear G of the engine.

The joint 28 transmits a motion of the plunger 23 to the shift lever 8 via the drive spring 27.

The main point of contact has a set of fixed contacts (not shown) connected to a power supply line of the motor 2 through two terminal bolts 29 and 30 fixed to the resin cover 24, and a moving contact (not shown) that is interlocked with the motion of the plunger 23 and electrically intermits between the set of fixed contacts.

The main point of contact closes when the plunger 23 is attracted by the electromagnet and moves to the right in FIG. 1, and the moving contact contacts to the set of fixed contacts so that the set of fixed contacts is closed, while the main point of contact opens when the attraction force of the electromagnet disappears and the plunger 23 is pushed back by the return spring 26, and the moving contact separates from the set of fixed contacts so that the fixed contacts are opened.

The shift lever 8 has a lever fulcrum part 8a supported rotatably by the housing 17, and one end of the lever is connected with the joint 28 of the electromagnetic switch 9 while another end of the lever is engaged with the lever engaging portion 19 attached to the main tube body 6A.

Next, the operation of the starter 1 is explained.

When a starter switch (not shown) is closed by a user, the exciting coil 25 of the electromagnetic switch 9 is energized from a battery and the electromagnet is formed, thus the plunger 23 moves by the attraction force of the electromagnet.

The pinion tube 6 is pushed out together with the pinion 7 in the anti-motor side direction by the motion of the plunger 23 being transmitted to the pinion tube 6 via the shift lever 8.

At this time, if the pinion 7 does not mesh with the ring gear G and an end surface of the pinion 7 contacts an end surface of the ring gear G, movement of the pinion 7 stops, and only the pinion tube 6 is pushed out pushing and contracting the pinion spring 21.

Then, if the plunger 23 further moves storing reaction force in the drive spring 27 and closes the main point of contact, torque is generated by the motor 2 in response to the electric power supply from the battery.

After being amplified by the speed reducer 3, the torque generated in the motor 2 is transmitted to the output shaft 5 via the clutch 4, and further transmitted to the pinion tube 6 from the output shaft 5, so that the pinion tube 6 rotates.

When the pinion 7 rotates to the position where meshing with the ring gear G becomes possible by the rotation of the pinion tube 6, the pinion tube 6 is pushed out by the reaction force stored in the drive spring 27 and a thrust (forwarding force) in the axial direction generated by exchanging the torque generated by the motor 2 by the male and the female helical splines 5a and 6a.

Furthermore, the meshing of the pinion 7 and the ring gear G is completed by the pinion 7 being pushed out by the reaction force of the pinion spring 21.

Thereby, the torque generated by the motor 2 is transmitted to the ring gear G from the pinion 7, and cranks (starts) the engine.

When the starter switch is opened by the user after the engine has started by cranking, the plunger 23 is pushed back by the reaction force of the return spring 26 because the energizing to the exciting coil 25 is stopped and the attraction force of the electromagnet has disappeared.

As a result, the main point of contact opens and the energizing to the motor 2 from the battery is stopped, and rotation of the armature slows down gradually and finally stops.

Moreover, when the plunger 23 is pushed back, the shift lever 8 swings to an opposite direction to a direction at the time of starting the engine and pushes back the pinion tube 6 in the motor side direction, so that the pinion 7 separates from the ring gear G and moves back together with the pinion tube 6 to produce the stopped condition of the starter 1 shown in FIG. 2A.

### [Function and Effect of the First Embodiment]

In the starter 1 shown in the first embodiment, the pinion sliding part 6B is formed on the end in the front end side of the pinion tube 6 supported by the housing 17 through the bearing 16, and the pinion 7 is meshed in a direct spline fitting manner to the perimeter of the pinion sliding part 6B and attached thereto.

In other words, the starter 1 is a cantilever structure that does not have a bearing that supports the pinion tube 6 in the front end side from the pinion 7.

In the starter 1, the pinion tube 6 is attached to the perimeter of the output shaft 5 by helical spline fitting, and is pushed out by the electromagnetic switch 9 in the anti-motor side direction relative to the output shaft 5 when starting the engine.

Moreover, the end in the rear end side of the output shaft 5 is disposed together with the inner 4b of the clutch 4.

According to this composition, the output shaft 5 and the clutch 4 do not move when starting the engine.

Moreover, since the pinion tube 6 is attached to the perimeter of the output shaft 5 by helical spline fitting and attached movably in the axial direction relative to the output shaft 5, the main tube body 6A is formed in a hollow shape.

Thereby, the weight of the pinion tube 6 can be reduced.

Accordingly, since the masses of moving bodies including the pinion tube 6 and the pinion 7 can be made small in the starter 1 of the first embodiment, the electromagnetic switch 9 that generates the attraction force for pushing out moving bodies via the shift lever 8 can be miniaturized.

Furthermore, the starter 1 of the present embodiment does not have the structure that the inner 4b of the clutch 4 meshes with the output shaft 5 gears by helical spline fitting, but the rear end of the output shaft 5 is formed together with the inner 4b of the clutch 4.

In this case, the clearances (clearance that occurs between the outer 4a and the roller 4c and the clearance that occur between the roller 4c and inner 4b) that occur in the clutch 4 and the clearance that occurs between the male helical spline 5a formed in the output shaft 5 and the female helical spline 6a formed in the pinion tube 6 do not overlap in the axial direction.

In other words, since the clearances that occur in the clutch 4 and the clearance that occurs in the spline part are separated in the axial direction, inclination of the pinion tube 6 can be suppressed.

As a result, since wear of the bearings 10 and 16 that support the pinion tube 6 and the gears 3a, 3b, and 3c that constitute the speed reducer 3 can be suppressed, the life of the starter 1 can be extended.

Moreover, the pinion 7 is formed separately with the pinion tube 6, attached movably in the axial direction relative to the pinion sliding part 6B, and is energized by the pinion spring 21 to the front end side.

According to this composition, when the pinion 7 is rotated by the rotation of the motor 2 to the position where the pinion 7 can mesh with the ring gear G after the pinion pushed out by the electromagnetic switch 9 in the anti-motor side direction together with the pinion tube 6 contacts the end face of the ring gear G, the pinion 7 can be selectively pushed out without moving other unnecessary components by the reaction force of the pinion spring 21 thus the ease of engagement of the pinion 7 and the ring gear G may be improved.

Moreover, by forming the large hole 7c in the inner circumference in the rear end side of the pinion 7, the pinion spring 21 can be arranged to the space formed between the large hole 7c and the outer surface of the pinion sliding part 6B, and the perimeter of the end in the front end side of the main tube body 6A is fit into the inner circumference of the end in the rear end side of the large hole 7c, thus the pinion spring 21 is not exposed directly to outside.

Thereby, an environmental resistance of the pinion spring 21 can be secured and performance degradation can be suppressed.

Furthermore, the communicating slot 18 is formed on at least one of the sliding surfaces 5α and 6α in the output shaft 5 and the pinion tube 6.

Since the communicating slot 18 is communicating with the space S formed inside of the pinion tube 6 and the rear end side of the cylindrical hole 6b, load being applied to the pinion tube 6 can be made small when the pinion tube 6 moves in the axial direction relative to the output shaft 5.

That is, assuming that the space S mentioned above is substantially sealed, when the pinion tube 6 is pushed out when the starter 1 is stopped, a capacity of the space S becomes large and air inside the space S expands, hence internal pressure drops.

On the other hand, when the pinion tube 6 is pushed back when the starter 1 is driven, the capacity of the space S becomes small and the air inside the space S is compressed, hence internal pressure rises.

A change of internal pressure acts as load when the pinion tube 6 moves in the axial direction.

By contrast, since the air can move easily through the communicating slot 18 between the space S and space S′ when the pinion tube 6 moves in the axial direction by forming the communicating slot 18 that communicates the space S and the rear end side of the cylindrical hole 6b, the load being applied to the pinion tube 6 becomes small.

As a result, the pinion tube 6 can be moved more smoothly.

Moreover, the pinion tube 6 is supported by the output shaft 5 in the inner circumference of the cylindrical hole 6b, and forms the inner circumference side pressure-receiving range α that receives the contacting pressure from the output shaft 5 on the sliding surface 6α.

Furthermore, the pinion tube 6 is supported by the bearing 16 from the perimeter side, and forms the perimeter side pressure-receiving range β that receives the contacting pressure from the bearing 16 on the sliding surfaces 6β.

Moreover, the forward end 5s of the output shaft 5 is in the forward end side beyond a forward end βf of the perimeter side pressure-receiving range β.

Further, the overlapping range γ that overlaps in the axial direction exists in the inner circumference side pressure-receiving range α and the perimeter side pressure-receiving range β, and length of the overlapping range γ in the axial direction is always equal to length of the perimeter side pressure-receiving range β in the axial direction even if the pinion tube 6 moves in the axial direction.

Thereby, the inclination of the output shaft 5 or the pinion tube 6 can be suppressed, and a longer service life can be attained since the overlapping range γ can be maintained to the maximum regardless of the starter 1 is being driven or stopped.

That is, when the forward end 5s of the output shaft 5 is in the forward end side beyond the forward end βf of the perimeter side pressure-receiving range β, the area of the overlapping range γ can be maximized by configuring the inner circumference side and the perimeter side pressure-receiving ranges α and β so that length in the axial direction of the overlapping range γ may always become equal to length of the perimeter side pressure-receiving range β in the axial direction.

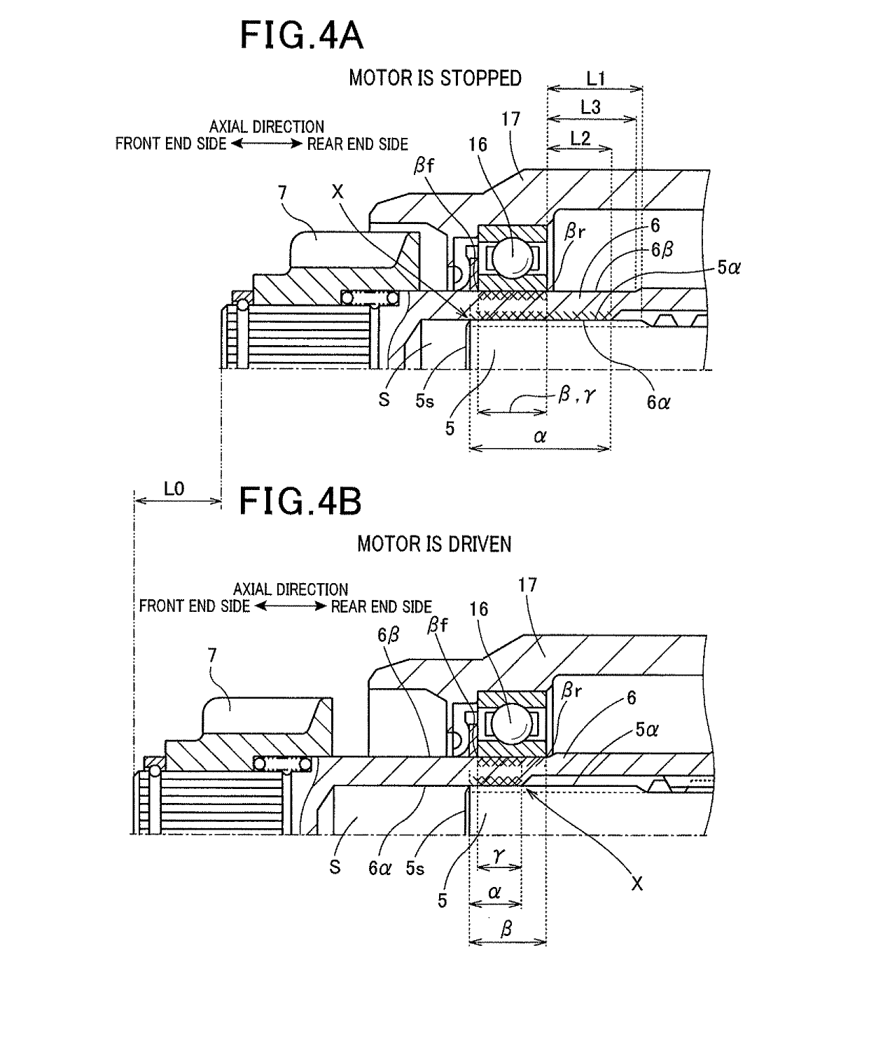

As shown in a first comparative example shown in FIG. 4A and FIG. 4B, for example, when the inner circumference side and the perimeter side pressure-receiving ranges α and β are configured so that the length L2 of the sliding surfaces 6α when the starter 1 is stopped becomes shorter than the movement value L0, although the length of the overlapping range γ in the axial direction is equal to the length of the perimeter side pressure-receiving range β in the axial direction when the starter 1 is stopped, when driving, the length of the overlapping range γ in the axial direction becomes shorter than the length of the perimeter side pressure-receiving range β in the axial direction.

For this reason, when the area of the overlapping range γ of the first comparative example and the area of the overlapping range γ of the first embodiment are compared, the area of the overlapping range γ in the first embodiment becomes larger than that of the first comparative example when the starter 1 is stopped.

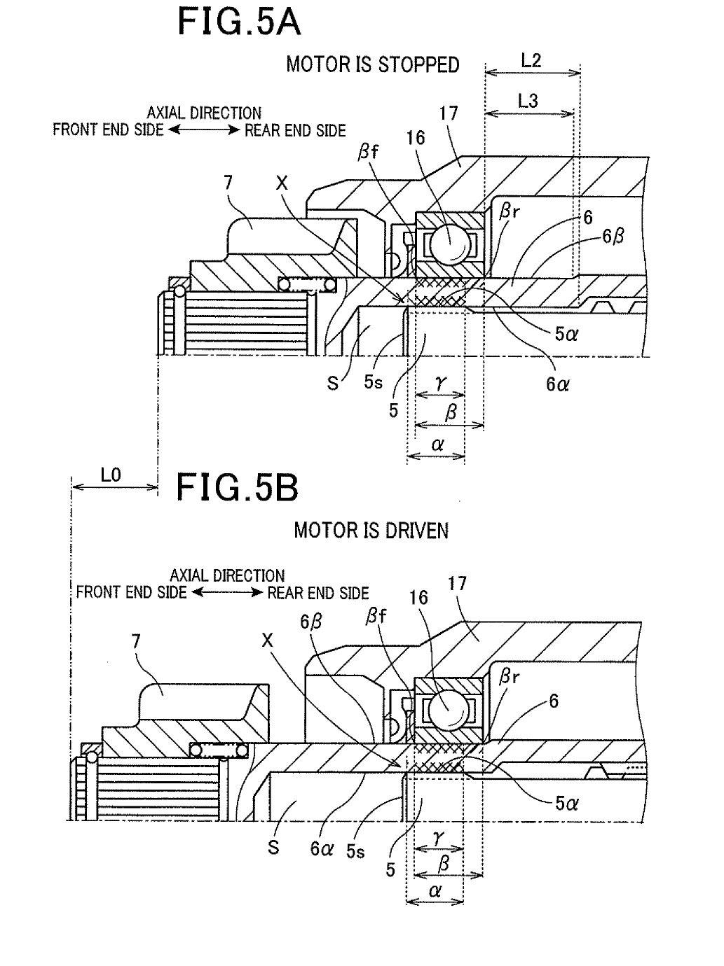

Moreover, as shown in a second comparative example shown in FIG. 5A and FIG. 5B, when the inner circumference side and the perimeter side pressure-receiving ranges α and β are configured so that the rear end of the sliding surface 5α is in the forward end side beyond the rear end βr of the perimeter side pressure-receiving range β when the starter 1 is stopped, although the length of the overlapping range γ in the axial direction is always constant regardless of the starter 1 being driven or stopped, the length of the overlapping range γ in the axial direction always becomes shorter than the length of the perimeter side pressure-receiving range β in the axial direction.

For this reason, when the area of the overlapping range γ of the second comparative example and the area of the overlapping range γ of the first embodiment are compared, the area of the overlapping range γ in the second embodiment becomes larger than that of the second comparative example when the starter 1 is either stopped or driven.

By this, when the forward end 5s of the output shaft 5 is in the forward end side beyond the forward end βf of the perimeter side pressure-receiving range β, the area of the overlapping range γ can be maximized by configuring the inner circumference side and the perimeter side pressure-receiving ranges α and β so that length in the axial direction of the overlapping range γ may always become equal to the length of the perimeter side pressure-receiving range β in the axial direction.

For this reason, since the contacting pressure that acts on the pinion tube 6 from the output shaft 5 via a supporting structure X (refer to FIG. 3A and FIG. 3B) constituted between the output shaft 5 and the pinion tube 6, and the contacting pressure that acts on the output shaft 5 from the pinion tube 6 via the supporting structure X can be minimized regardless of the starter 1 being driven or stopped, wear can be suppressed in the supporting structure X.

As a result, the inclination of the pinion tube 6 to the output shaft 5 and the inclination of the pinion tube 6 to the output shaft 5 can be suppressed, thus the a longer service life of the starter 1 can be attained.

Here, the supporting structure X of the first embodiment is a direct contacting type that the inner surface of the pinion tube 6 and the outer surface of the output shaft 5 contact directly and slide mutually (i.e., the sliding surfaces 5α and 6α slide mutually directly).

For this reason, wear of the supporting structure X of the first embodiment arises in the sliding surfaces 5α and 6α, and occurs when the sliding surfaces 5α and 6α slide mutually directly.

According to the starter 1 of the first embodiment, by suppressing wear that has occurred accordingly, the inclination of the pinion tube 6 to the output shaft 5 and the inclination of the output shaft 5 to the pinion tube 6 can be suppressed, and the a longer service life of the starter 1 can be attained.

### Second Embodiment

It should be appreciated that, in the second embodiment, components identical with or similar to those in the first embodiment are given the same reference numerals for the sake of omitting explanation.

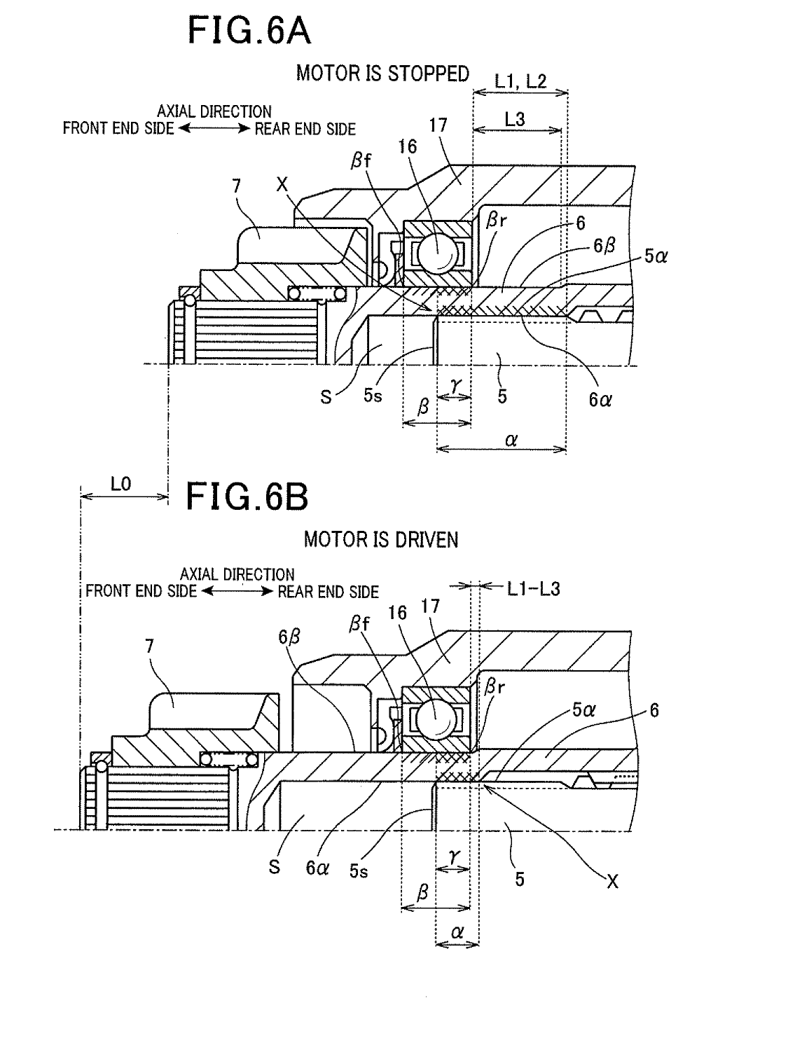

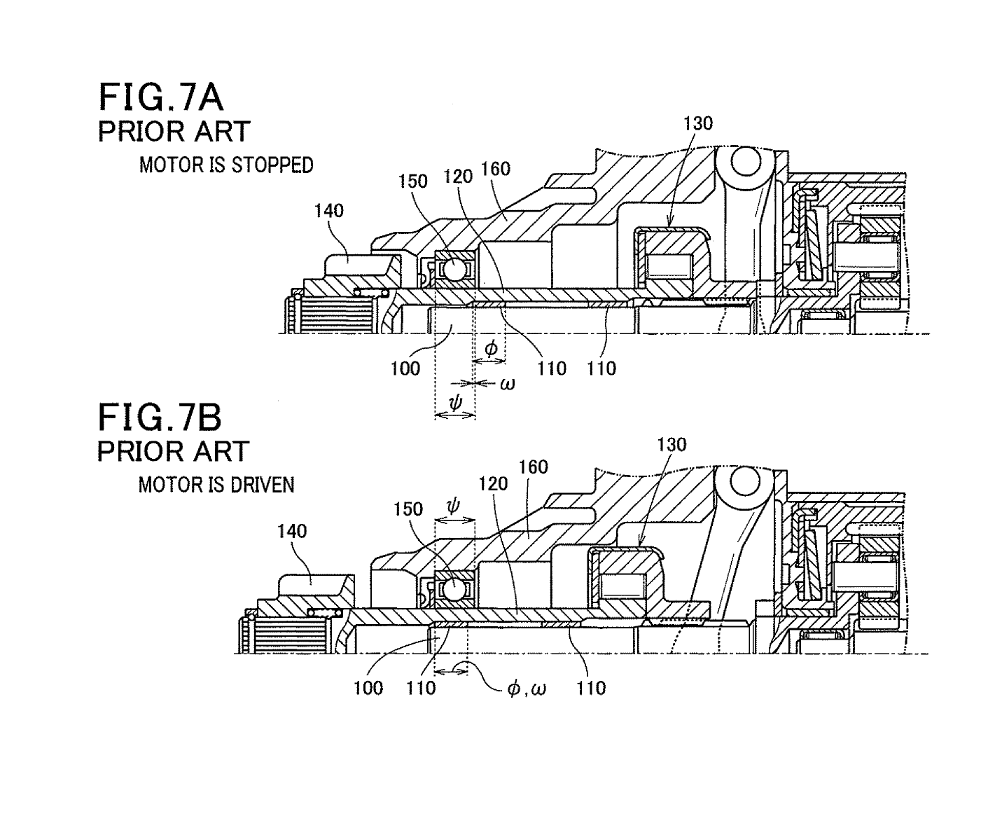

According to the starter 1 of the second embodiment, as shown in FIG. 6A and FIG. 6B, the forward end 5s of the output shaft 5 is in the rear end side beyond the forward end βf of the perimeter side pressure-receiving range β, and is in the forward end side beyond the rear end βr of the perimeter side pressure-receiving range β (i.e., the forward end 5s of the output shaft 5 is in the perimeter side pressure-receiving range β in the axial direction).

Moreover, the bearing 16 is located at a constant axial position relative to the output shaft 5 in the axial direction so that the bearing 16 overlaps with the output shaft 5 in the axial direction.

Furthermore, the length of the overlapping range γ in the axial direction always substantially matches with the length of the overlap of the output shaft 5 and the bearing 16 in the axial direction regardless of the starter 1 being driven or stopped.

Thereby, the inclination of the output shaft 5 or the pinion tube 6 can be suppressed, and a longer service life can be attained since the overlapping range γ can be maintained to the maximum regardless of the starter 1 being driven or stopped.

That is, when the forward end 5s is within the perimeter side pressure-receiving range β in the axial direction, the area of the overlapping range γ can be maximized by configuring the inner circumference side and the perimeter side pressure-receiving ranges α and β so that the length of the overlapping range γ in the axial direction may always be substantially matched with the length of the overlap of the output shaft 5 and the bearing 16 in the axial direction.

For this reason, since the contacting pressure that acts on the pinion tube 6 from the output shaft 5 via a supporting structure X and the contacting pressure that acts on the output shaft 5 from the pinion tube 6 via the supporting structure X can be minimized, wear can be suppressed in the supporting structure X.

As a result, the inclination of the pinion tube 6 to the output shaft 5 and the inclination of the pinion tube 6 to the output shaft 5 can be suppressed, thus the a longer service life of the starter 1 can be attained.

In addition, in order to always keep the overlapping range γ constant regardless of the starter 1 being driven or stopped, the sliding surfaces 5α, 6α, and 6β are configured like those of the starter 1 in the first embodiment.

That is, when the starter 1 is stopped, the sliding surfaces 5α, 6α, and 6β are configured such that the lengths L1 and L2 are equal and become longer than the movement value L0 and the length L3 so that the length L3 becomes equal to the movement value L0, for example.

Moreover, the starter 1 of the second embodiment suppresses the wear in the supporting structure X by maximizing the overlapping range γ when the forward end 5s of the output shaft 5 is in the perimeter side pressure-receiving range β, and the perimeter side pressure-receiving range β is smaller compared with that of the starter 1 in the first embodiment that has the forward end 5s in the forward end side of the overlapping range.

Thus, a reason for disposing the forward end 5s of the output shaft 5 in the perimeter side pressure-receiving range β even though the overlapping range γ becomes small is based on the moment of force that acts on parts disposed coaxially such as the output shaft 5, the pinion tube 6, the pinion 7, the motor 2, and the components of the speed reducer 3 (the parts other than the pinion 7 are hereafter called pinion coaxial parts among these parts) as explained below.

That is, when an area supported by the bearing 16 is used as a fulcrum of the moment of force that acts on the pinion 7 and the pinion coaxial parts, the pinion coaxial parts receive load due to the load that the pinion 7 receives from the ring gear G at the time of starting the engine, and the moment by these loads balances. Here, it is desirable that the load received by the pinion coaxial parts is minimized because it causes wear.

Then, the bearing 16 is brought closer to the pinion 7 in the axial direction, and the forward end 5s of the output shaft 5 is configured in the perimeter side pressure-receiving range β.

Thereby, the moment of the load that the pinion 7 receives from the ring gear G can be reduced, and as a result, the load that the pinion coaxial parts receive can be reduced.

Therefore, by configuring the forward end 5s of the output shaft 5 in the perimeter side pressure-receiving range β, the load that the pinion coaxial parts receive can be reduced by reducing the moment of force that acts on the pinion 7 and the pinion coaxial parts at the time of starting the engine, thus wear of the pinion coaxial parts can be suppressed.

### [Modification]

The clutch 4 used in the first embodiment is a roller type clutch that uses the rollers 4c as the power intermittence member.

However, a sprag type clutch using a sprag as a power intermittence member or a cam type clutch using a cam as a power intermittence member may be used replacing the rollers 4c.

Moreover, the motor 2 used for the starter 1 is not limited to the direct-current (DC) commutator motor 2 as in the first embodiment, but an alternating-current (AC) motor can also be used, for example.

The pinion 7 is formed separately with the pinion tube 6 and is meshed in a direct spline fitting manner to the perimeter of the pinion sliding part 6B in the first embodiment.

However, the pinion 7 and the pinion tube 6 may be formed unitarily.

The electromagnetic switch 9 of the first embodiment drives the shift lever 8 and closes the main point of contact by the movement of the plunger 23 attracted by the electromagnet.

However, an action that drives the shift lever 8 and pushes out the pinion tube 6 in the anti-motor side direction, and an action that opens and closes the main point of contact may be performed by a separate solenoid.

Namely, an electromagnetic switch of tandem structure with a pinion extrusion solenoid (electromagnetic solenoid of the present disclosure) for driving the shift lever 8 to push out the pinion tube 6 in the anti-motor side direction and a motor energizing solenoid that opens and closes the main point of contact to intermit an energizing current of the motor 2 may be used.

Furthermore, both the pinion extrusion solenoid and the motor energizing solenoid may be accommodated in a common frame to constitute them as a single electromagnetic switch.

However, both solenoids may also be accommodated independently in exclusive frames.

The electromagnetic switch of tandem structure can control independently the operation of the pinion extrusion solenoid and the operation of the motor energizing solenoid by an ECU, and therefore may be adopted suitably to a ISS (idling stop system) that has been employed in vehicles in recent years.

The ISS is a system that stops fuel injection to an engine to stop the engine automatically when the vehicle stops at a traffic light or during a traffic jam, for example.

Moreover, according to the starter 1 of the first and second embodiments, regarding the lengths L1-L3 in the axial direction to which the sliding surfaces 5α, 6α, and 6β extend in the rear end side beyond the rear end βr, the length L3 is equal to the movement value L0, and the lengths L1 and L2 are equal mutually and longer than the movement value L0 and the length L3 when the starter 1 is stopped.

However, as long as the lengths L1-L3 are longer than the movement value L0, it is not limited to modes in the first and second embodiments, but various modes can be adopted.

Moreover, according to the starter 1 of the first and second embodiments, although the supporting structure X constituted between the output shaft 5 and the pinion tube 6 is the direct contacting type that the inner surface of the pinion tube 6 and the outer surface of the output shaft 5 contact directly and slide mutually (i.e., the sliding surfaces 5α and 6α slide mutually directly), a mode of the supporting structure X is not limited to the direct contacting type.

That is, the supporting structure X of the starter 1 may be what is called an indirect contacting type (a mode that inserts a bearing etc. between the sliding surfaces 5α and 6α, and have the sliding surfaces 5α and 6α contacted indirectly through the bearing etc.).

In addition, in a case of the indirect contacting type, wear of the supporting structure X occurs when an inner surface of a bearing, etc. and the sliding surfaces 5α slide mutually directly, or when an outer surface of the bearing, etc. and the sliding surfaces 6α slide mutually directly, and wear may occur not only in the sliding surfaces 5α and 6α but also in an inner and outer surfaces of the bearing, etc.

In addition, according to the starter 1 of the present modification, by suppressing the occurrence of wear, the inclination of the pinion tube 6 to the output shaft 5 and the inclination of the pinion tube 6 to the output shaft 5 can be suppressed, thus the a longer service life of the starter 1 can be attained.

What is claimed is:

1. A starter comprising:
a motor that generates torque;
an output shaft disposed coaxially with a rotating shaft of the motor;
a male spline formed on an outer surface of the output shaft;
a clutch that transmits the torque generated by the motor to the output shaft;
a pinion tube that has a cylindrical hole where a female spline is formed in an inner surface thereof and an anti-motor side in an axial direction of the output shaft is inserted into an inner circumference of the cylindrical hole so that the male spline and the female spline are meshed;
a pinion disposed on an end of the pinion tube in the anti-motor side in the axial direction and which rotates together with the pinion tube; and
an electromagnetic solenoid that drives a shift lever by an attraction force of an electromagnet and pushes out the pinion tube together with the pinion in the anti-motor side direction relative to the output shaft via the shift lever; wherein,
the pinion is engaged with a ring gear of an engine by pushing out the pinion tube in the anti-motor side direction relative to the output shaft when triggered by the electromagnetic solenoid;
the pinion tube is supported by the output shaft in the inner circumference of the cylindrical hole;
an inner circumference side pressure-receiving range that receives a contacting pressure from the output shaft is formed on the inner surface of the pinion tube;
the pinion tube is supported by a bearing located at a constant axial position relative to the output shaft in the axial direction from a perimeter side thereof;
a perimeter side pressure-receiving range that receives the contacting pressure from the bearing is formed on an outer surface of the pinion tube;
the bearing is located at a constant axial position relative to the output shaft in the axial direction so as to overlap with the output shaft in the axial direction;
an end of the output shaft in the anti-motor side in the axial direction is in aside of a motor of the perimeter side pressure-receiving range in the axial direction beyond an end in the anti-motor side in the axial direction, and is in the anti-motor side of the perimeter side pressure-receiving range in the axial direction beyond an end in the motor side in the axial direction;
there exists an overlapping range that overlaps in the axial direction between the inner circumference side pressure-receiving range and the perimeter side pressure-receiving range; and
a length of the overlapping range in the axial direction substantially matches the length of the overlap between the output shaft and the bearing in the axial direction even if the pinion tube moves in the axial direction.

2. A starter comprising:
a motor that generates torque;
an output shaft disposed coaxially with a rotating shaft of the motor;
a male spline formed on an outer surface of the output shaft;
a clutch that transmits the torque generated by the motor to the output shaft;
a pinion tube that has a cylindrical hole where a female spline is formed in an inner surface thereof and an anti-motor side in an axial direction of the output shaft is inserted into an inner circumference of the cylindrical hole so that the male spline and the female spline are meshed;
a pinion disposed on an end of the pinion tube in the anti-motor side in the axial direction and which rotates together with the pinion tube; and
an electromagnetic solenoid that drives a shift lever by an attraction force of an electromagnet and pushes out the pinion tube together with the pinion in the anti-motor side direction relative to the output shaft via the shift lever; wherein,
the pinion is engaged with a ring gear of an engine by pushing out the pinion tube in the anti-motor side direction relative to the output shaft when triggered by the electromagnetic solenoid;
the pinion tube is supported by the output shaft in the inner circumference of the cylindrical hole;
an inner circumference side pressure-receiving range that receives a contacting pressure from the output shaft is formed on the inner surface of the pinion tube;
the pinion tube is supported by a bearing located at a constant axial position relative to the output shaft in the axial direction from a perimeter side thereof;
a perimeter side pressure-receiving range that receives the contacting pressure from the bearing is formed on an outer surface of the pinion tube;
there exists an overlapping range that overlaps in the axial direction in the inner circumference side pressure-receiving range and the perimeter side pressure-receiving range; and
a length of the overlapping range in the axial direction is always equal to a length of the perimeter side pressure-receiving range in the axial direction even if the pinion tube moves in the axial direction.
